(19) United States
(12) Patent Application Publication
(10) Pub. No.: US 2008/0002529 A1
(43) Pub. Date: Jan. 3, 2008

(54) Optical head and optical recording apparatus

(75) Inventors: Koujirou Sekine, Ibaraki-shi (JP); Hiroaki Ueda, Suita-shi (JP); Manami Kuiseko, Kyoto-shi (JP); Naoki Nishida, Kusatsu-shi (JP); Kenji Konno, Sakai-shi (JP); Masahiro Okitsu, Higashiosaka-shi (JP); Hiroshi Hatano, Takatsuki-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/821,697

(22) Filed: Jun. 25, 2007

(30) Foreign Application Priority Data
Jun. 30, 2006 (JP) 2006-181127

(51) Int. Cl. G11B 5/127; G11B 5/31; G11B 5/39; G11B 7/00

(52) U.S. Cl. 369/13.33; 360/59; 369/100; 369/13.17; 369/44.11

(57) ABSTRACT

An optical head having: a graded index lens which receives incident light radiated from a linear optical guide at one end surface of the graded index lens and transmits the incident light from the other end surface of the graded index lens, the graded index lens is adapted to form a light spot at a position that is away from the other end surface from which the incident light is transmitted; a light path deflection section which deflects light transmitted from the graded index lens, the light path deflection section is arranged between the other end surface from which the incident light is transmitted and the position where the light spot is formed; and a slider which floats on a recording medium while moving relative to the recording medium, wherein at least the graded index lens and the light path deflection section are installed on the slider.

### CROSS REFERENCE TO RELATED APPLICATION

The present application is based on Japanese Patent Application No. 2006-181127 filed in Japan on Jun. 30, 2006, the entire contents of which are incorporated herein by reference.

### TECHNICAL FIELD

This invention relates to an optical head and optical recording apparatus.

### BACKGROUND OF THE INVENTION

In a magnetic recording mode, a magnetic bit is affected greatly by environment such as ambient temperature when a recording density becomes high. Because of this, a recording medium having coercive force is required. But when using such recording medium, strong magnetic field is required for recording. Higher limit of a magnetic filed generated by a recording head is determined by a saturation magnetic flux density. But the value of the higher limit of the magnetic field is close to material limit and significant increase of the value can not expected. And so, proposed is a method of recording on the recording medium while coercive force becomes small during the temporary magnetic softening of the recording medium caused by locally heating, stopping locally heating and naturally cooling the recording medium, where the method ensures a stability of the magnetic bit. This method is called thermally assisted magnetic recording system.

In the thermally assisted magnetic recording system, it is preferable to heat the recording medium instantaneously. And the mechanism to heat the recording medium is not allowed to contact with the recording medium. Accordingly, it is usual to heat the recording medium utilizing absorption of light and the system utilizing absorption of light is called optically assisted system. In a case of ultrahigh-density recording by optically assisted recording system, a necessary size of an optical spot is about 20 nm. But ordinal optical system cannot condense the optical spot to such extent due to diffraction limit.

Therefore, near field optical head, which uses near field light that is generated from an optical aperture of a size smaller than a wavelength of an incident light. But the existing near field optical head has a problem to be solved, which is low optical efficiency. There are some methods to solve such problem.

For example, U.S. Pat. No. 6,795,380 discloses an optically-assisted magnetic recording head to record information magnetically on a medium comprising: a pair of magnetic yokes having a gap therebetween, irradiation of light onto the gap generating an evanescent light; and a magnetic field generator applying a magneto-motive force to the magnetic yokes to build a recording magnetic field across the gap, the information being recorded by the recording magnetic field on the medium which is heated by irradiation of the evanescent light thereto.

Japanese unexamined patent application publication No. 2003-6913 discloses a near field optical head including: a slider formed on a substrate and an optical aperture of a size less than a wavelength of an incident light, the optical aperture is formed on the substrate, wherein the near field optical head records and/or reproduces information by floating from a surface of a recording medium with a predetermined distance, wherein the floating power is generated by mutual movement between the slider and the surface of the recording medium, and having interaction with the surface of the recording medium via a near field light generated from the optical aperture, and wherein the near field optical head includes cyclic convex concave structure formed of metal, the structure is arranged around the optical aperture on the substrate and the optical aperture is arrange within the plane defined by a base end face of the slider, and convex portion of the convex concave structure is arranged on a light incident side with respect to the plane defined by the base end face of the slider.

And United States patent publication Number 2006/0045419 A1 discloses an optical fiber coupling part capable of reducing coupling loss while maintaining a large operating distance, and having a good module assembling property. At least one GRIN lens having numerical aperture NA that is larger than numerical aperture NAs of a light-emitting source (such as a semiconductor laser) is fusion-spliced with one end of the optical fiber. The optical fiber coupling part can exit light flux introduced in the optical fiber as condensed light while maintaining a large operating distance by utilizing a GRIN lens that is fusion-spliced with the optical fiber having a large numerical aperture and loss of the light can thereby be reduced.

But for the optically assisted magnetic recording head disclosed in U.S. Pat. No. 6,795,380, there is a description about irradiating light on the gap generating near field light. The description is that the slider is carved with a groove on its top, in which an optical fiber is embedded, and the light beam emitted from the optical fiber is reflected by the prism, and after passing through the transparent dielectric block, it is irradiated to form a light spot near the gap of the recording element. Accordingly, there is no description about that the light emitted from one end of the optical fiber diffuses in a space between the one end of the optical fiber and the gap generating the evanescent light. Therefore it is easy to predict low optical efficiency of the light emitted from the one end of the optical fiber.

In the near field optical head disclosed in Japanese unexamined patent application publication No. 2003-6913, a light emitted from the optical fiber is reflected by a mirror surface and the reflected light is condensed by a micro lens and irradiated on a near field light generator. In this case, there is large loss of light at a deflection surface of the mirror and an incident surface of the micro lens. Therefore it is considered that optical efficiency of the light emitted from the one end of the optical fiber is not good. And it is difficult to make the near field optical head thin because the optical axis of the micro lens coincides with the direction in which the slider floats.

In the optical coupling part disclosed in United States patent publication Number 2006/0045419 A1, it is possible to condense the light flux introduced in the optical fiber to an optical spot of a size, for example the same size as the size of light emitting point of light emitting source LD (Laser Diode), with a GRIN lens having large numerical aperture. There is a description that the operating distance (a distance from light emitting edge face to the optical spot) is set to 30 μm, in this case, to obtain high coupling efficiency. In the case of utilizing the optical coupling part for an optical head, an optical path deflecting means such as a prism will be required when trying to deflect the light emitting from the optical fiber, for example about 90 degree, with respect to a light emitting direction. The optical length of the optical path deflecting means is required to be equal or less than a value that is given by multiplying the refractive index of the material comprising the prism by said 30 μm. It is difficult to structure such optical path deflecting means.

With a development of a high density information recording in an information-recording device such as HDD (Hard Disk Drive) in recent years, miniaturization of a recording/reproducing head and miniaturization of a slider which configures the head are desired. The size of the slider is standardized as IDEMA (International Disk Drive Equipment and Materials Association) standard. In descending order, sliders are named as Mini slider, Micro slider, Nano slider, Pico slider and Femto slider. In theses sliders, Nano slider, Pico slider and Femto slider have gotten attention recently from a viewpoint of a size. Sizes and masses of theses sliders are indicated on Table 1.

TABLE 1

| | Size (length × width × thichness | Mass |
|---|---|---|
| Name of Slider | (mm)) | (mg) |
| Nano slider | 2.05 × 1.60 × 0.43 | 5.5 |
| Pico slider | 1.25 × 1.00 × 0.30 | 1.5 |
| Femto slider | 0.85 × 0.70 × 0.23 | 0.5 |

Further, in high density information recording, as understandable from the size of sliders indicated in Table 1, it is necessary not only to make the information density on one disc high, but also to provide spatially high density slider by placing discs multilayered or by storing in a small box. For example, when assuming the case of placing discs multilayered, distances between each discs are required to be minimum and thickness of the optical head including the thickness of the slider indicated in Table 1 is expected to be 1.5 mm or less.

### SUMMARY OF THE INVENTION

This invention was conceived in view of the above problems and the object thereof is to provide an optical head with good luminous efficacy and low height, and an optical recording apparatus that uses this optical head.

The foregoing problems are solved by the following construction.

An optical head comprising: a graded index lens which receives incident light radiated from a linear optical guide at one end surface of the graded index lens and transmits the incident light from the other end surface of the graded index lens, the graded index lens is adapted to form a light spot at a position that is away from the other end surface from which the incident light is transmitted; a light path deflection section which deflects light transmitted from the graded index lens, the light path deflection section is arranged between the other end surface from which the incident light is transmitted and the position where the light spot is formed; and a slider which floats on a recording medium while moving relative to the recording medium, wherein at least the graded index lens and the light path deflection section are installed on the slider.

### BRIEF DESCRIPTION OF THE DRAWINGS

FIG. 1 shows an example of the optical recording apparatus.

FIG. 2 is a cross-sectional view showing an example of the assist type magnetic recording head including a magnetic recording element in the optical head.

FIGS. 3(A) and 3(B) show examples of a bench.

FIGS. 4(A), 4(B) and 4(C) show an example of an optical waveguide.

FIGS. 5(A), 5(B) and 5(C) show examples of a plasmon probe.

FIG. 6 is a cross-sectional view showing an example of the structure of an optical head.

FIG. 7 is a cross-sectional view showing an example of the structure of an optical head.

FIG. 8 is a cross-sectional view showing an example of the structure of an optical head.

FIG. 9 is a cross-sectional view showing an example of the structure of an optical head.

FIG. 10 is a cross-sectional view showing an example of the structure of an optical head.

FIG. 11 is a cross-sectional view showing an example of the structure of an optical head.

FIG. 12(A) is a cross-sectional view showing an example of the structure of an optical head and FIG. 12(B) is a perspective view showing a prism portion.

FIG. 13(A) is a cross-sectional view showing an example of the structure of an optical head and FIG. 13(B) is a perspective view showing a prism portion.

### DESCRIPTION OF THE PREFERRED EMBODIMENTS

The following is a description with reference to drawings, of an optically assisted type magnetic recording head which includes a magnetic recording element in the optical head of this invention and the optical recording device comprising this optically assisted type magnetic recording head. It is to be noted that for each of the embodiments the same parts have been assigned the same reference numbers and repeated descriptions thereof have been omitted.

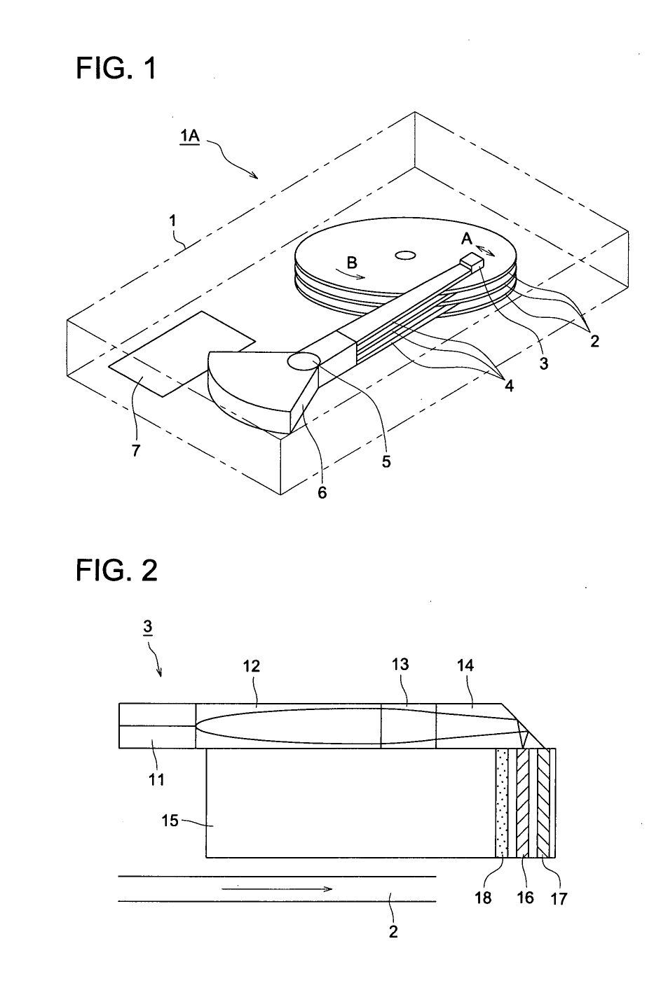

FIG. 1 shows an example of the schematic structure of the optical reading device (example, hard disk device) in which an optically assisted type magnetic recording head is loaded. The optical recording apparatus 1A comprises in a case, a recording disk (magnetic recording medium) 2; a suspension 4 that is provided so as to be rotatable in the direction of arrow A (tracking direction) with support shaft 5 as a support point; a tracking actuator 6 that is mounted on the suspension 4; an optically assisted type magnetic recording head (called optical head hereinafter) 3 that is mounted on the front end of the suspension 4; and a motor (not shown) for rotating the disk 2 in the arrow B direction, a control section 7 to control the tracking actuator 6, the motor and recording, and the optical head 3 can move relative to the disk 2 while floating thereon.

FIG. 2 shows an example of the optical head 3. The optical head 3 is an optical head which utilizes light in recording information on the disk 2 and comprises an optical system comprising an optical fiber 11 which is the linear optical guiding element for guiding the light to the optical head 3; an optical assist section (optical waveguide) 16 for performing spot heating using near infrared light on the portion for recording of the disk 2; graded index lens 12 and 13 which guide the near infrared laser light output from the optical fiber 11 to the optical assist section 16; and a prism 14 which is a light path deflection section; a magnetic recording section 17 which performs writing of magnetic information in the portion for recording of the disk 2; and a magnetic reproduction section 18 for reading the magnetic information recorded on the disk 2.

It is to be noted that in FIG. 2, the magnetic reproduction section 18, the optical waveguide 16 and the magnetic recording section 17 are sequentially arranged from the approach side to the exit side of the recording region of the disk 2 (→ direction in the drawing), but the arrangement sequence is not limited thereto. The magnetic recording section 17 may be positioned immediately after the exit side of the optical waveguide 16, and thus the order may be optical waveguide 16, magnetic recording section 17, then magnetic reproduction section 18.

The light that is guided by the optical fiber 11 may, for example, be light that is output by a semiconductor laser, and the wavelength of this light is preferably the near infrared wavelength of 1.2 μm or more. (Near infrared wavelength is about 0.8 μm-2 μm and specific examples of the wavelength of the laser light are 1310 nm and 1550 nm). The near infrared laser light that was output from the end surface of the optical fiber 11 is focused on the surface of the optical waveguide 16 that is on the slider 15 using the optical system (the graded index lens 12 and 13 and the prism 14), and passes through the optical waveguide 16 which forms the optical assist section, and is output from the optical head 3 to the disk 2.

The slider 15 moves relative to the magnetic recording medium while sliding above it, but foreign matter that attaches to the medium, or defects of the medium, makes contact possible. In order to reduce the wear occurring at this time, it is preferable that an anti-wear material with a high degree of hardness is used for the material of the slider. For example, a ceramic material including Al₂O₃ such as AlTiC or zirconium TiN or the like may be used. A surface processing for increasing anti-wear properties on the disk 2 side of the slider 15 may be performed as anti-wear processing. For example if a DLC (diamond like carbon) coating is used, the near infra-red transmittance is high and hardness of Hv=30 which is second only to diamond can be obtained.

In addition, the surface facing the disk 2 of the slider 15 may have a surface called an air bearing surface (ABS) for improving floating.

When the near infrared laser light output from the optical head 3 is radiated into the disk 2 as a tiny spot, the temperature of the portion of the disk 2 that is irradiated temporarily increases and the holding power of the disk 2 reduces. Magnetic information is written on the irradiated portion with reduced holding power by the magnetic recording section 17. The optical system for the optical head 3 will be described in the following.

First the graded index lens 12 and 13 will be described. The graded index lens (called GRIN lens hereinafter) are cylindrical lens which use media with different refractive indexes (refractive index is larger as the center is approached), and the lens are operated by continuously changing the refractive index. A specific examples of GRIN lens is SiGRIN (registered trademark) (silica GRIN, Toyo Glass Co., Ltd). The radial direction graded index n(r) is shown by formula (1)

n(r)=N0+NR2×R² (1), where:

n(r): refractive index at position of distance r from the center; N0: refractive index at center portion; NR2: Constant showing the focusing power of the GRIN lens.

One feature of the GRIN lens is that aligning the optical axis is easy because it has graded index in the radial direction. For this reason, the optical axis of the optical fiber 11 and the GRIN lens 12 and 13 can be easily aligned. In addition, in the case where the optical fiber is formed from quartz, because the material forming the GRIN lens 12 and the GRIN lens 13 is the same as that of the optical fiber, they can be integrally formed by melting to join them. This joining causes handling to be easy, and at the same time, light loss is suppressed at the surface where the optical fiber 11 and the GRIN lens 12 and the GRIN lens 13 respectively connect and the light guided by the optical fiber can be effectively output by the GRIN lens 13.

The GRIN lens 12 and the GRIN lens 13 which are the graded index lens have structure in which the light guided by the optical fiber 11 is focused at a position away from the light output surface of the GRIN lens 13 to form a light spot. The NA of the GRIN lens 12 and the GRIN lens 13 are different and by selecting one of, or combining the GRIN lens 12 and the GRIN lens 13, and by appropriately determining the respective lengths, the length of the graded index lens and the distance from the light output surface of the graded index lens to the light spot position can be determined.

The distance from the end surface where light is output on the graded index lens to the position where the light spot is formed preferably satisfies the conditional equation below.

0.5×d×n<s<n×b+n×(b²+f²)^{1/2} (2)

where d: diameter of the graded index lens; s: length of the light path from the end surface where light is output on the graded index lens to the position where the light spot is formed; b: length of the slider in the direction where the graded index lens and the light deflection section are aligned; n: refractive index of the medium in the light path from the end surface where light is output on the graded index lens to the position where the light spot is formed; f: the maximum permissible height in the direction in which the slider floats from the position where the light spot is formed to the position where the light from the graded index lens provided on the slider is output.

The conditional equation (2) defines the permissible range from the end surface on the graded index lens where light is output to the position where the light spot is formed, given that at least graded index lens and a first light path deflection section are provided on the slider having the length b and a light spot can be formed on the upper surface or lower surface of the slider.

If the lower limit of conditional equation (2) is exceeded, a light path deflecting section such as a prism which deflects the light path cannot be used. In addition if the upper limit of the conditional equation (2) is exceeded, it becomes impossible to form a light spot at a prescribed position which is on the upper surface or the lower surface of the slider with one of the light deflection section such as the graded index lens which focus light flux on the upper surface of the slider having a length b.

The length of the slider shown in the conditional equation (2) can be used for the size (length) of the nano slider, the pico slider, and the femto slider shown in Table 1. The height f may be suitably determined by the height of the optical head and may, for example, be about 1 mm.

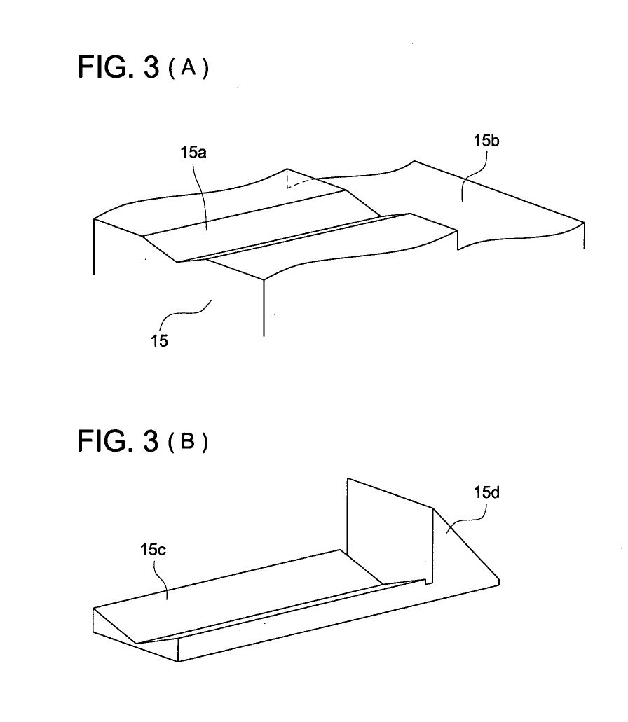

The diameter of GRIN lens 12 and GRIN lens 13 which are the graded index lens and the diameter of the optical fiber 11 are preferably substantially the same ±10%, and they are even more preferably the same. Because the optical fiber 11, the GRIN lens 12 and the GRIN lens 13 can be joined by melting as described above, if they all have substantially the same diameter, it is easy to align the centers and perform the joining operation. In addition, in the case where the optical fiber 11, the GRIN lens 12 and the GRIN lens 13 that are joined on the slider 15 (simply called joined optical elements hereinafter) are provided at a prescribed position, the height and direction of the joined optical elements can be set with high accuracy and fixed with an adhesive or the like by causing the configuration to have a simple V groove (see FIGS. 3(A) and 3(B)) on the slider 15. Furthermore, if the diameter of the GRIN lens 12 and the GRIN lens 13 are the same as the diameter of the optical fiber, the optical head can be made thinner as a matter of course.

In the case where the graded index lens and the optical fiber are provided on the slider 15, a V-groove or a member including a V-groove is prepared (called bench hereinafter) and after the graded index lens and the optical fiber are fixed in this bench, it may be fixed on the slider 15 and the bench structure may also be formed directly on the opposite surface to the surface facing the magnetic recording surface of the slider 15.

An example of the bench is shown in FIGS. 3(A) and 3(B). FIG. 3(A) shows the bench on which a V-groove 15a is provided directly on the upper surface of the slider 15. 15b shows the surface for fixing the prism. The V-groove 15a of FIG. 3 (A) may be formed as a separate member which is a bench. Also, FIG. 3 (B) shows a bench which is formed as a separate member from the slider and in which V-groove 15c and the prism 15d are integrally formed.

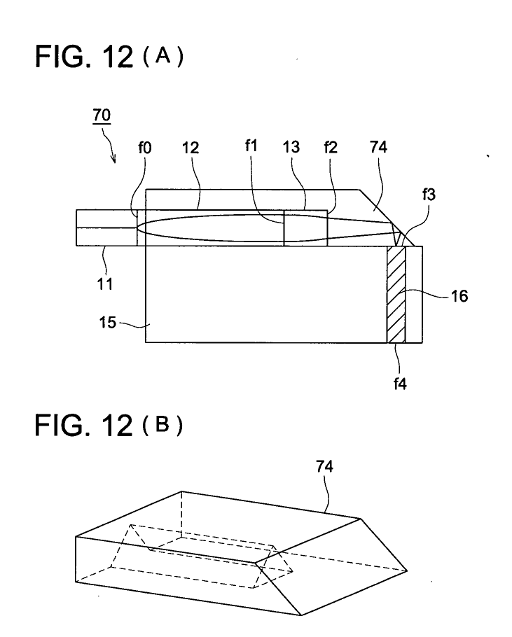

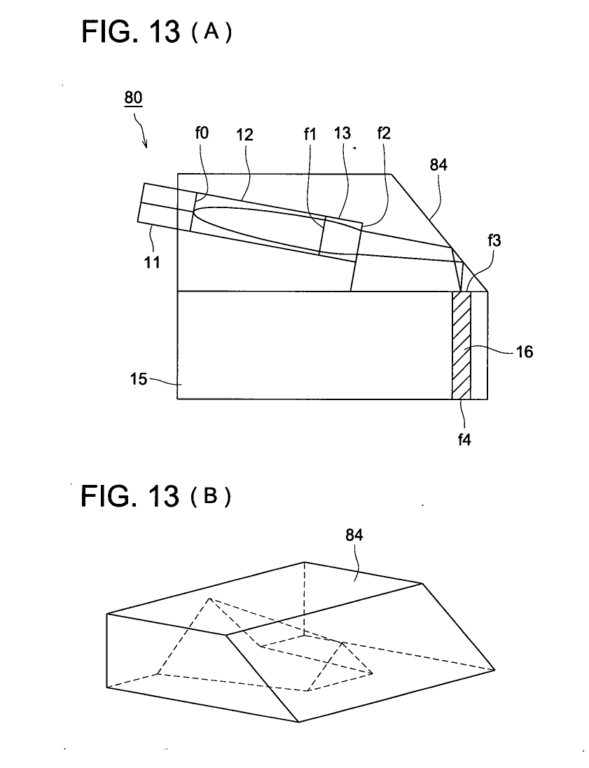

Of course, the bench and the slider may be integrally formed. Also, other examples in which the V-groove and the prism are integral are shown in prism 74 of FIGS. 12(A) and 12(B) and prism 84 of FIGS. 13(A) and 13(B) (see working examples 7 and 8).

When the V-groove and the prism are integral, the positional relationship between the prism and the joined optical elements can be simple, and the optical head can be assembled accurately and simply. It is to be noted that in FIG. 2 and FIG. 6 to FIG. 11, the bench portion is not shown.

Also, by providing the V-groove, the height of the graded index lens and the optical axis direction can be stipulated and movement in the optical axis direction can be done easily, and for example, assembly by pressing the light output surface of the GRIN lens which has a flat end surface to the light incident surface of the prism can be easily done. In this manner, by bringing the light incident surface of the prism and the light output surface of the GRIN lens into close contact such that air is not caught between the surfaces, the light that is output from the optical fiber 11 can be input into the prism through the GRIN lens that are joined by the melting without passing through an air layer and thus an optical head with good luminous efficacy can be formed.

It is preferable that the prism 14, which is the light path deflection section for deflecting the light path between the light output surface of the GRIN lens 13 and the position of the light spot by 90°, is provided. By providing the prism 14, the advance direction of the light that is output from the optical fiber 11 that is parallel to the magnetic recording surface and converged by the GRIN lens 12 and the GRIN lens 13 which are the graded index lens can be made orthogonal to magnetic recording surface.

The height of the prism 14 is larger than the radius of the graded index lens which is optically joined with the prism, such as GRIN lens 13, and preferably less than substantially the same diameter thereof. By forming the prism 14 to have this height, the light path can be deflected without increasing loss of light output from the graded index lens while suppressing the height of the optical head.

In addition, the light path deflection section can be a mirror that has a light deflecting surface, but it is preferably a prism that can utilize total reflection in view of reflection efficiency. If the deflection surface is a mirror, the reflection efficiency is about 80%, while if a prism that utilizes total reflection is used, it can be close to 100%. Furthermore, in the case where total reflection is used, the refraction index for forming the prism is preferably large. When the refraction index is large, the angle of incidence formed by total reflection can be made smaller. That is to say, if, for example, the optical axis of the converging light flux is made incident on the deflection surface at an angle of incidence of 45°, the light flux is made incident with some width for the angle of incidence, but the amount of reflected light for light from the side where the angle of incidence is small can be increased.

The position for forming the spotlight using the graded index lens comprising the GRIN lens 12 and 13 is on the upper surface of the slider, and an optical waveguide is preferably provided directly therebeneath. By providing the optical waveguide, the light spot that converges on the upper surface of the slider can be efficiently guided to the lower surface of the slider without loss of the spot diameter. The direction of the light that converges in the optical waveguide is preferably substantially orthogonal with respect to the input surface for the optical waveguide. The guiding efficiency on the optical waveguide decreases with incline from the orthogonal direction, and when there is an incline of about 30°, little or no guiding is done, and thus by causing the direction to be substantially orthogonal ±10° C., light can be efficiently guided. For example, in the case where the optical waveguide is provided so as to incline with respect to the surface where the slider moves relatively, it is more preferable that the light incident end surface of the optical waveguide is formed as a surface that is orthogonal to the incoming light than as a surface that is parallel to the direction of movement of the slider, in view of luminous efficacy.

In addition, particularly in the case where the optical waveguide is provided orthogonal to the direction of relative movement of the slider, the converging light which has an angle for the light to converge does not need to pass inside the slider and thus the magnetic recording section and magnetic reproduction section can be easily provided at a position near the vicinity of the optical waveguide in the direction where the magnetic recording surface moves relatively. Thus an efficient optically assisted type optical head can be formed.

In addition, if the optical waveguide includes a light spot size conversion function which is described hereinafter, the diameter of the light spot formed on the input surface of the optical waveguide can be reduced at the output surface with respect to the diameter at the input surface of the optical waveguide. As a result, a smaller light spot diameter can be formed on the recording medium surface and this is suitable for high recording density.

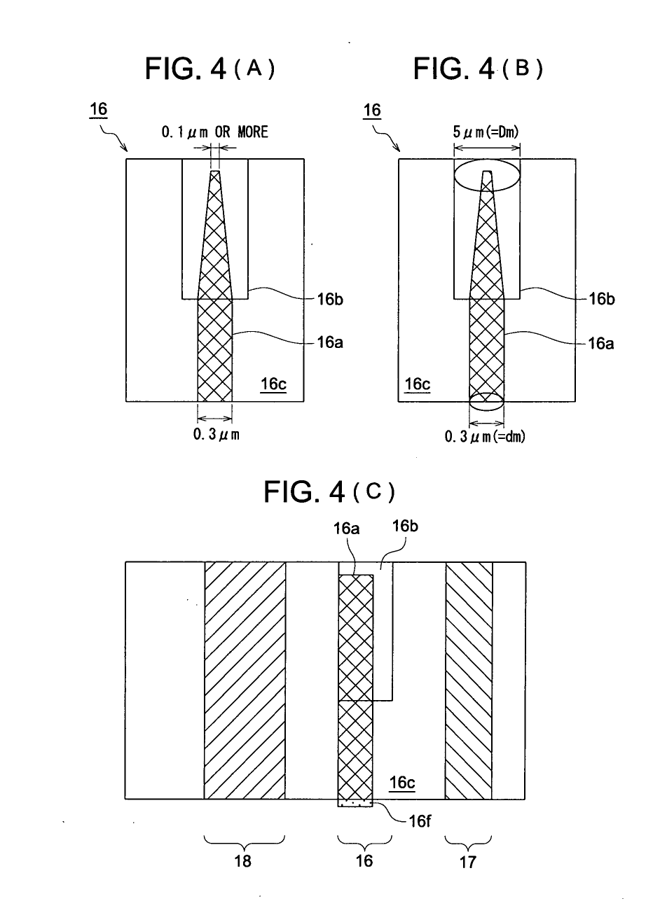

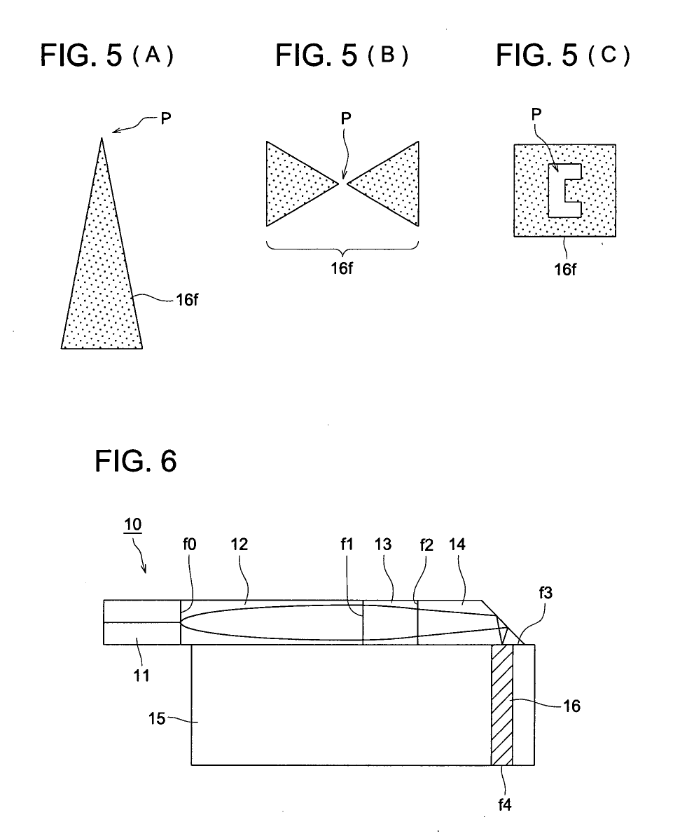

An example of the optical waveguide including a light spot size conversion function is shown in FIGS. 4(A), 4(B) and 4(C). FIGS. 4(A) and 4(B) show the portion of the optical waveguide viewed from the direction in which the optical head moves relatively, while FIG. 4(C) the view from orthogonal direction with respect to the direction of movement and the parallel direction with respect to the magnetic recording surface. The optical waveguide shown in FIGS. 4(A), 4(B) and 4(C) is formed of a core 16a (example Si), a sub-core 16b (example SiON) and a clad 16c (example SiO₂). As shown in FIG. 4(C), there is a plasmon probe 16f for near field light emission at the light output position of the optical waveguide or the vicinity thereof. A specific examples of the plasmon probe 16f are shown in FIGS. 5(A), (B) and (C).

FIG. 5(A) shows a plasmon probe 16f formed from a flat triangular thin metal film (material: aluminum, gold, silver or the like for example) and FIG. 5 (B) shows a plasmon probe 16f formed from a powder type flat thin metal film) (material: aluminum, gold, silver or the like for example) and each of them includes an antenna which has a peak which is less than the curve radius of 20 nm. FIG. 5 (C) shows also a plasmon probe 16f formed from a flat thin metal film (material: aluminum, gold, silver or the like for example) which has openings, and includes an antenna which has a peak) which is less than the curve radius of 20 nm. When light acts on these plasmon probes 16f, near field light is generated in the vicinity of the peak P, and recording or reproduction which uses light of an extremely small spot size can be performed. That is to say, by providing the plasmon probe 16f at the light output position of the optical waveguide or in the vicinity thereof, if local plasmon is generated, the size of the light spot formed by the optical waveguide can be made smaller and can be used in high density recording. It is to be noted that the peak P of the plasmon probe 16f is preferably positioned in the center of the core 16a.

The required spot diameter for performing super high density recording using the optically assisted type is approximately 20 nm, and when light use efficiency is considered, the mode field diameter (MFD) in the plasmon probe 16f is preferable about 0.3 μm. With this MFD size, light input is difficult and thus it is necessary to perform spot size conversion to decrease the spot diameter from about 5 μm to a few hundred nm. The example of the optical waveguide shown in FIGS. 4(A), 4(B) and 4(C) has a structure in which spot conversion is performed in order to facilitate light input.

In FIGS. 4(A), 4(B) and 4(C), as shown by the cross-section in FIG. 4(C), the width of the core 16a is constant from the light incident side to the light output side, but in the cross-section in FIG. 4(A) it changes so as to gradually widen from the input side to the output side in the sub-core 16b. The mode field diameter is changed due to smooth changes in the optical waveguide. That is to say, as shown in FIG. 4(A) the width of the core 16a of the optical waveguide is 0.1 μm or less at the light incident side and 0.3 μm at the light output side, but as shown in FIG. 4(B), at the input side, an optical waveguide of about 5 μm is formed by the sub-core 16b and then the optical waveguide is gradually optically bonded to the core 16a and the mode field diameter can be reduced. In this manner, given that the mode field diameter at the optical output side of the optical waveguide is dm and the mode field diameter at the optical input side of the optical waveguide is Dm, it is preferable that the mode field diameter is converted by smoothly changing the optical waveguide diameter such that Dm>dm is satisfied.

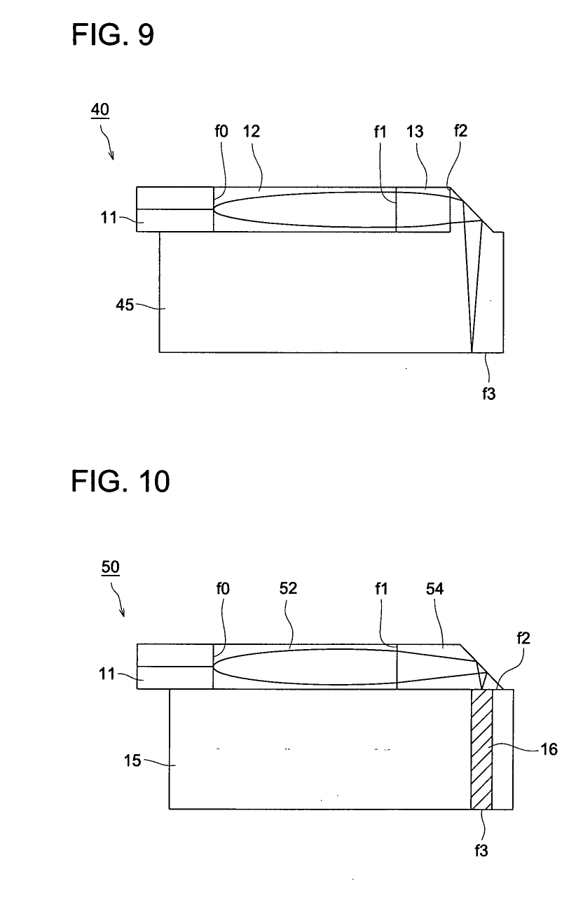

In addition, the optical head comprising an optical waveguide is described above, but in the optical systems shown in FIGS. 8 and 9 (See Working Examples 3 and 4 for details), the structure is such that the light that is guided by the optical fiber 11 focuses on the lower surface of the sliders 35 and 45 which float and run on the disk 2, and light is output from the optical heads 30 and 40 towards the disk (not shown). By having this kind of structure, an element for focusing light is not provided between the optical system and the slider, and thus the optical head can be formed thinner. In addition, because there is no optical waveguide, the structure of the sliders 35 and 45 is simple and the optical heads 30 and 40 can be formed easily. The conditional equation (2) can also be used for this structure.

The optical head described up to this point is an optically assisted type magnetic recording head which uses light for recording information on the disk 2, but an optical head which uses light for recording information on a recording medium and does not include magnetic reproduction section 17 and magnetic recording section 18 such as an optical head which performs near field or phase change recording or may be used and the plasmon probe 16f described above may be arranged at the light output position of the optical waveguide 16 or in the vicinity thereof.

### WORKING EXAMPLES

The following is a description of the working examples of this invention.

The common conditions in Working Examples 1 to 9 below are shown in the following. Equation (1) for the refraction index of the GRIN lens using wavelength 1.31 μm is shown again below.

n(r)=NO+NR2×r² (1),

where r is the distance from the center (distance in the diametrical direction from the center).

The constants required for showing the refraction index of GRIN lens A and GRIN lens B which are the graded index lens used in Working Examples 1 to 9 below Equation (1) above are shown below.

GRIN lens A (NA: 0.166)

N0=1.479606

NR2=−2.380952

GRIN lens B (NA: 0.395)

N0=1.540737

NR2=−12.47619

Diameter of GRIN A and GRIN B: 125 μm (in examples 1-8)

Diameter of GRIN A and GRIN B: 80 μm (in example 9)

In the examples below, the magnetic recording section, the magnetic reproduction section and the plasma probe are not included, but in the case of the optically assisted type magnetic recording head, or in the case where super high density recording is performed, these may, as a matter of course, be provided.

In the figures corresponding to Working Examples 1 to 6 and Example 9 respectively, the bench for fixing the joined optical elements in which the optical fiber, the GRIN lens A, GRIN lens B is not shown, but there is a bench comprising a V-groove on the surface of the slider.

The joining surface and the last end surface on the optical paths of FIG. 6-FIGS. 13(A) and 13(B) are assigned numbers from f0 to f1, f2, etc. These correspond respectively to light sources 1, 2 of the surfaces shown in the table corresponding to the figures describing the working examples below.

### Working Example 1

10 in FIG. 6 is the optical head, 11 is the optical fiber, 12 is the GRIN lens A, 13 is GRIN lens B, 14 is the prism, 15 is the slider and 16 is the optical waveguide.

In FIG. 6, GRIN lens A12, GRIN lens B13 and prism 14 are installed on the slider 15 formed of AlTiC of length of the pico slider (in the movement direction) of 1.25 mm, thickness (floating direction) of 0.3 mm, and depth of 1 mm. The light flux output from the optical fiber 11 with diameter 125 μm forms a parallel light flux using the GRIN lens A12 which have a length of 0.875 mm, and passes through the GRIN lens B13 with a length of 0.15 mm, and the parallel light enters as converging light into the prism 14 which is formed of quartz and whose deflection surface is 45°. The light flux that was deflected at approximately 90° by the prism 14 forms a light spot that is focused so as to be substantially orthogonal on the input end surface of the optical waveguide 16, and is thereby optically bonded. Three elements which are the optical fiber 11, the GRIN lens A12 and the GRIN lens B13 are joined by melting, and positioning can be performed as one unit, and the end surface of the GRIN lens B13 is pressed onto the light incident surface of the prism 14 and fixed by adhesion such that an air layer is not sandwiched between the surfaces. The mode field diameter of the optical fiber 11 is approximately 10 μm and the mode field diameter of the optical waveguide 16 is also approximately 10 μm. By combining the GRIN lens A12 and the GRIN lens B13, the light output from the optical fiber 11 can form light spots which correspond to the mode field diameter of the optical waveguide 16, and the magnification of the optical system can be 1:1.

The values of the GRIN lens 12 and 13 and the prism 14 are shown in Table 2 below.

TABLE 2

| | | Distance between | |
|---|---|---|---|
| | Curve | axis and upper | |
| Surface | radius | surface (mm) | Refraction index |
| (Light source) | ∞ | 0 | — |
| 1 | ∞ | 0.875 | See GRIN Lens A |
| 2 | ∞ | 0.15 | See GRIN Lens B |
| 3 | ∞ | 0.3376553 | 1.479606 |
| 4 | ∞ | — | — |

### Working Example 2

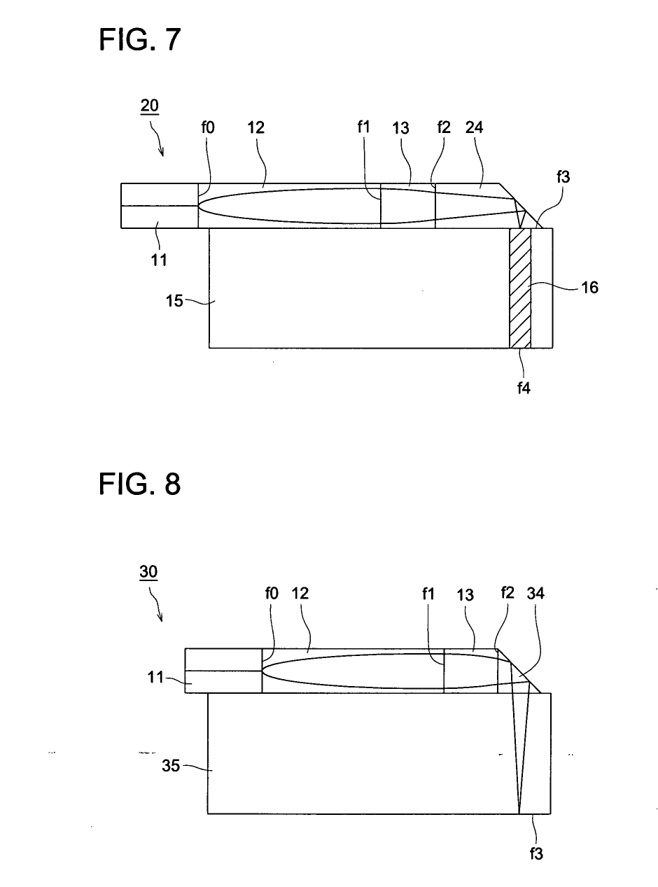

20 in FIG. 7 is the optical head, 11 is the optical fiber, 12 is the GRIN lens A, 13 is GRIN lens B, 24 is the prism, 15 is the slider and 16 is the optical waveguide.

In FIG. 7, the GRIN lens A12, GRIN lens B13 and the prism 24 are installed on the slider 15. The light output from the optical fiber 11 passes through the GRIN lens A12, GRIN lens B13 and enters as converging light into the prism 24 which is formed of SF6 glass and whose deflection surface is 45°. The light flux that was deflected at approximately 90° by the prism 24 forms a light spot that is focused so as to be substantially orthogonal to the input end surface of the optical waveguide 16, and is optically bonded. Three elements which are the optical fiber 11, the GRIN lens A12 and the GRIN lens B13 are joined by melting, and positioning can be performed as one unit, and the end surface of the GRIN lens B13 is pressed onto the light incident surface of the prism 24 and fixed by adhesion such that an air layer is not sandwiched between the surfaces. The mode field diameter of the optical fiber 11 is approximately 10 μm and the mode field diameter of the optical waveguide 16 is also approximately 10 μm. By combining the GRIN lens A12 and the GRIN lens B13, the light output from the optical fiber 11 can form light spots which correspond to the mode field diameter of the optical waveguide 16, and the magnification of the optical system can be 1:1.

Because the material or forming prism 24 is SF6 glass which has a larger refractive index than quartz in Working Example 1 above, reflectance due to total reflection on the deflection surface can be increased and luminous efficacy thereby increased.

The values for the GRIN lenses 12 and 13 and the prism 24 are shown in Table 3 below.

TABLE 3

| | | Distance between | |
|---|---|---|---|
| | Curve | axis and upper | |
| Surface | radius | surface (mm) | Refraction index |
| (Light source) | ∞ | 0 | — |
| 1 | ∞ | 0.875 | See GRIN Lens A |
| 2 | ∞ | 0.15 | See GRIN Lens B |
| 3 | ∞ | 0.4128449 | 1.76812808 |
| 4 | ∞ | — | — |

### Working Example 3

30 in FIG. 8 is the optical head, 11 is the optical fiber, 12 is the GRIN lens A, 13 is GRIN lens B, 34 is the prism and 35 is the slider.

In FIG. 8, optical fiber 11, GRIN lens A12, GRIN lens B13 and prism 34 are installed on the slider 35 formed from SF6 through which light from an optical fiber of length 1.25 mm, thickness 0.3 mm, and depth of 1 mm can pass. The light output from the optical fiber 11 passes through the GRIN lens A12, GRIN lens B13 and enters as converging light, into the prism 34 which is formed of SF6 glass and whose deflection surface is 45°. The light flux that was deflected at approximately 90° by the prism 34 can form a light spot that is focused on the lower surface of the slider 35. Because the slider 35 does not have an optical waveguide, the structure of the slider 35 can be simple. Three elements which are the optical fiber 11, the GRIN lens 12 and the GRIN lens 13 are joined by melting, and positioning can be performed as one unit, and the end surface of the GRIN lens B13 is pressed onto the light incident surface of the prism 34 and fixed by adhesion such that an air layer is not sandwiched between the surfaces. The mode field diameter of the optical fiber 11 is approximately 10 μm and because the size of the focus spot on the lower surface of slider 35 is also 10 μm, the magnification of the optical system is 1:1.

The values for the GRIN lenses 12 and 13 and the prism 34 are the same as in Table 3 above.

### Working Example 4

40 in FIG. 9 is the optical head, 11 is the optical fiber, 12 is the GRIN lens A, 13 is GRIN lens B, and 45 the slider which is integral with the prism.

As is the case in Working Example 3, because the slider 35 does not have an optical waveguide, the structure of the slider 35 can be simple. Furthermore because the prism and the slider are integrally formed, the structure is such that assembly is easy.

The values for the GRIN lenses 12 and 13 and the prism and slider 45 are the same as in Table 3 above.

50 in FIG. 10 is the optical head, 11 is the optical fiber, 52 is the GRIN lens B, 54 is the prism, 15 is the slider and 16 is the optical waveguide.

In FIG. 10, the optical fiber 11, GRIN lens B52 and the prism 54 are installed on the slider 15. The light output from the optical fiber 11 passes through the GRIN lens B52 having a length of 0.565 mm and enters as converging light into the prism 54 which is formed of SF6 glass of height 0.125 mm, length 0.336 mm and depth 0.125 mm and whose deflection surface is 45°. By forming the graded index lens as one of the GRIN lens B52, the structure can be made simple. The light flux that was deflected at approximately 90° by the prism 54 forms a light spot that is focused so as to be substantially orthogonal to the input end surface of the optical waveguide 16, and is optically bonded. The optical fiber 11, and the GRIN lens 52 are joined by melting, and positioning can be performed as one unit, and the end surface of the GRIN lens B52 is pressed onto the light incident surface of the prism 54 and fixed by adhesion such that an air layer is not sandwiched between the surfaces. The light output from the optical fiber 11 having a mode field diameter of approximately 10 μm suppresses the length of GRIN lens B52 by having one GRIN lens B52 and the length of the prism 54 can be ensured. Because the length of the GRIN lens B52 is suppressed, the converged state of the light has a small structure with small NA. As a result, the size of the light spot is approximately 20 μm and the magnification of the optical system can be 2:1.

The values for the GRIN lens B52 the prism 54 are shown in Table 4 below.

TABLE 4

| | | Distance between | |
|---|---|---|---|
| | Curve | axis and upper | |
| Surface | radius | surface (mm) | Refraction index |
| (Light source) | ∞ | 0 | — |
| 1 | ∞ | 0.564685 | See GRIN Lens B |
| 2 | ∞ | 0.3367499 | 1.76812808 |
| 3 | ∞ | — | — |

### Working Example 6

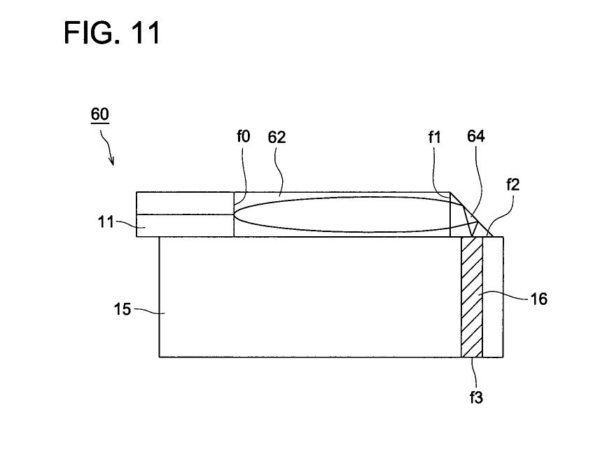

60 in FIG. 11 is the optical head, 11 is the optical fiber, 62 is the GRIN lens B, 64 is the prism, 15 is the slider and 16 is the optical waveguide.

In FIG. 11, the optical fiber 11, GRIN lens B62 and the prism 64 are installed on the slider 15. The light flux from the optical fiber 11 passes through the GRIN lens B62 having a length of approximately 0.678 mm and enters as converging light into the prism 64 which is formed of SF6 glass of height 0.125 mm, length 0.125 mm and depth 0.125 mm and whose deflection surface is 45°. By forming the graded index lens as one of the GRIN lens B62, the structure is simplified. The light flux that was deflected at approximately 90° by the prism 64 forms a light spot that is focused so as to be substantially orthogonal to the input end surface of the optical waveguide 16, and is optically bonded. The optical fiber 11 and the GRIN lens B62 are joined by melting, and positioning can be performed as one unit, and the end surface of the GRIN lens B62 is pressed onto the light incident surface of the prism 64 and fixed by adhesion such that an air layer is not sandwiched between the surfaces. The light output from the optical fiber 11 having a mode field diameter of approximately 10 μm has a larger converged state and larger NA as a result of having one GRIN lens B62 and making the length of GRIN lens B62 long compared to that of Working Example 5. As a result, the size of the optical spot is approximately 14 μm and the magnification of the optical system can be 1:4:1.

The specifications for the GRIN lens B62 and the prism 64 are shown in Table 5 below.

TABLE 5

| | | Distance between | |
|---|---|---|---|
| | Curve | axis and upper | |
| Surface | radius | surface (mm) | Refraction index |
| (Light source) | ∞ | 0 | — |
| 1 | ∞ | 0.6776729 | See GRIN Lens B |
| 2 | ∞ | 0.125 | 1.76812808 |
| 3 | ∞ | — | — |

### Working Example 7

70 in FIG. 12(A) is the optical head, 11 is the optical fiber, 12 is the GRIN lens A, 13 is the GRIN lens B, 74 is the prism that is formed integrally with the V-groove, 15 is the slider and 16 is the optical waveguide. FIG. 12(B) is a perspective view of the prism 74 that is integrally formed with the V-groove.

In FIG. 12 (A), the prism 74 that is integrally formed with the V-groove is installed on the slider 15. Three elements which are the optical fiber 11, the GRIN lens A12 and the GRIN lens B13 are joined by melting with the V groove of the prism 74 that is integral with the V-groove to form one unit, and the end surface of the GRIN lens B13 is pressed onto the light incident surface of the prism 74 and fixed by adhesion such that an air layer is not sandwiched between the surfaces.

The light flux from the optical fiber 11 passes through the GRIN lens A12 and the GRIN lens B13 and enters as converging light into the prism 74 that is integral with the V-groove and made of polycarbonate and whose deflection surface is 45°. The light flux that was deflected at approximately 90° by the prism 74 that is integral with the V-groove forms a light spot that is focused so as to be substantially orthogonal to the input end surface of the optical waveguide 16, and is optically bonded.

The mode field diameter of the optical fiber 11 is approximately 10 μm and the mode field diameter of the optical waveguide 16 is also approximately 10 μm. By combining the GRIN lens A12 and the GRIN lens B13, the light output from the optical fiber 11 can form light spots which correspond to the mode field diameter of the optical waveguide 16, and the magnification of the optical system can be 1:1.

The values for the GRIN lenses 12 and the 13 and the prism 74 are shown in Table 6 below.

TABLE 6

| | | Distance between | |
|---|---|---|---|
| | Curve | axis and upper | |
| Surface | radius | surface (mm) | Refraction index |
| (Light source) | ∞ | 0 | — |
| 1 | ∞ | 0.875 | See GRIN Lens A |
| 2 | ∞ | 0.125 | See GRIN Lens B |
| 3 | ∞ | 0.364518 | 1.559211 |
| 4 | ∞ | — | — |

### Working Example 8

80 in FIG. 13(A) is the optical head, 11 is the optical fiber, 12 is the GRIN lens A, 13 is the GRIN lens B, 84 is the prism that is integral with the V-groove and inclines at 10°, 15 is the slider and 16 is the optical waveguide. FIG. 13(B) is a perspective view of the prism 84 that is integral with the V-groove in FIG. 13(A).

In FIG. 13(A), the prism 84 that is integral with the V-groove is installed on the slider 15. Three elements which are the optical fiber 11, the GRIN lens A12 and the GRIN lens B13 are joined by melting with the V-groove of the prism 84 that is integral with the V-groove to form one unit, and the end surface of the GRIN lens B13 is pressed onto the light incident surface of the prism 84 and fixed by adhesion such that an air layer is not sandwiched between the surfaces.

The light flux from the optical fiber 11 passes, through the GRIN lens A12 and the GRIN lens B13 and enters as converging light into the prism 84 that is integral with the V-groove and made of polycarbonate and whose deflection surface is 50°. The light flux that was deflected at approximately 100° by the prism 84 that is integral with the V-groove forms a light spot that is focused so as to be substantially orthogonal to the input end surface of the optical waveguide 16, and is optically bonded. Because the angle for deflection the light flux is 100°, the reflection state at the deflection surface of the prism made of polycarbonate which has a smaller refraction index than SF6, is a state close to total reflection, and furthermore, by inclining the V-groove at 10°, because light is input in the orthogonal direction with respect to the input surface of the optical waveguide 16, the luminous efficacy is better than that of Working Example 7. The mode field diameter of the optical fiber 11 is approximately 10 μm and the mode field diameter of the optical waveguide 16 is also approximately 10 μm. By combining the GRIN lens A12 and the GRIN lens B13, the light output from the optical fiber 11 can form light spots which correspond to the mode field diameter of the optical waveguide 16, and the magnification of the optical system can be 1:1.

The values for the GRIN lenses 12 and the 13 and the prism 84 are the same as those of Table 6 above.

### Working Example 9

10 in FIG. 6 is the optical head, 11 is the optical fiber, 12 is the GRIN lens A, 13 is GRIN lens B, 14 is the prism, 15 is the slider and 16 is the optical waveguide.

In FIG. 6, GRIN lens A12, GRIN lens B13 and prism 14 are installed on the slider 15 formed of AlTiC of length of the pico slider (in the movement direction) of 1.25 mm, thickness (floating direction) of 0.3 mm, and depth of 1 mm. The light flux output from the optical fiber 11 with diameter 80 μm forms a parallel light flux using the GRIN lens A12 which have a length of 0.875 mm, and passes through the GRIN lens B13 with a length of 0.310792 mm, and the parallel light enters as converging light into the prism 14 which is formed of quartz and whose deflection surface is 45°. The light flux that was deflected at approximately 90° by the prism 14 forms a light spot that is focused so as to be substantially orthogonal on the input end surface of the optical waveguide 16, and is thereby optically bonded. Three elements which are the optical fiber 11, the GRIN lens A12 and the GRIN lens B13 are joined by melting, and positioning can be performed as one unit, and the end surface of the GRIN lens B13 is pressed onto the light incident surface of the prism 14 and fixed by adhesion such that an air layer is not sandwiched between the surfaces. The mode field diameter of the optical fiber 11 is approximately 3.3 μm and the mode field diameter of the optical waveguide 16 is also approximately 11.87 μm. By combining the GRIN lens A12 and the GRIN lens B13, the light output from the optical fiber 11 can form light spots which correspond to the mode field diameter of the optical waveguide 16, and the magnification of the optical system can be 1:0.57.

The values of the GRIN lens A 12, the GRIN lens B 13 and the prism 14 are shown in Table 7 below.

TABLE 7

| | | Distance between | |
|---|---|---|---|
| | Curve | axis and upper | |
| Surface | radius | surface (mm) | Refraction index |
| (Light source) | ∞ | 0 | — |
| 1 | ∞ | 0.875 | See GRIN Lens A |
| 2 | ∞ | 0.310792 | See GRIN Lens B |
| 3 | ∞ | 0.08 | 1.521414476 |
| 4 | ∞ | — | — |

### (Suitability of Conditional Equation (2))

In Working Examples 1-9, the maximum permissible height f from the position where the light spot is formed to the position where the light from the graded index lens provided on the slider is 1 mm. Whether the conditional equation 2 is suitable or unsuitable is shown in Table 7. As shown in Table 8, it is clear that it is suitable in all of Working Examples 1-9.

TABLE 8

| | | | | Suitable/ |
|---|---|---|---|---|
| | | | | Unsuitable |
| | | | | for |
| | | | | conditional |
| | 0.5 × d × n | S | n × (b + (b² + f²)^{1/2}) | equation |
| Working | 0.092475 | 0.499597 | 4.216877 | Suitable |
| Example 1 | | | | |
| Working | 0.110508 | 0.729963 | 5.039165 | Suitable |
| Examples | | | | |
| 2, 3, 4 | | | | |
| Working | 0.092475 | 0.595417 | 5.039165 | Suitable |
| Example 5 | | | | |
| Working | 0.110508 | 0.221016 | 5.039165 | Suitable |
| Example 6 | | | | |
| Working | 0.097451 | 0.568360 | 4.443751 | Suitable |
| Examples | | | | |
| 7, 8 | | | | |
| Working | 0.060857 | 0.121713 | 4.336031 | Suitable |
| Example 9 | | | | |

According to this invention, in a state where a linear optical guide and a graded index lens are arranged in a straight line, a light spot can be formed on a line extended therefrom and by including a light path deflection section, the light path can be deflected at 90°. As a result, a linear optical guide and graded index lens are provided parallel to the recording medium surface and light in the orthogonal direction of the recording medium surface converges and the light spot is formed. Furthermore, a light incident end surface of a prism which is a linear optical guide, a graded index lens, and a light path deflection section may be formed in a density state where there is little light loss.

And, by changing combination of the GRIN lenses, it is possible to select image formation magnification from enlargement, same size and reduction, freely. A lot of flexibility for the parts (optical fiber, optical waveguide) arranged at both side of the GRIN les is attained. As a result of the flexibility, an optical head that is optically high efficient and being small height could be attained. To be more precise, generally when utilizing an optical waveguide, image formation magnification becomes enlargement and then the size of the optical spot becomes larger than the incident surface of the optical waveguide. Accordingly, connection efficiency at the incident side of the optical waveguide becomes extremely low. Further, when generating near field light, efficiency of convergence to near field light becomes low. By using two GRIN lenses, it becomes possible to provide optically high efficient structure depending on the parts to be used.

Thus an optical head with good luminous efficacy and low height, and an optical recording apparatus using this optical head is provided.

What is claimed is:

1. An optical head comprising:
a graded index lens which receives incident light radiated from a linear optical guide at one end surface of the graded index lens and transmits the incident light from the other end surface of the graded index lens, the graded index lens is adapted to form a light spot at a position that is away from the other end surface from which the incident light is transmitted;
a light path deflection section which deflects light transmitted from the graded index lens, the light path deflection section is arranged between the other end surface from which the incident light is transmitted and the position where the light spot is formed; and
a slider which floats on a recording medium while moving relative to the recording medium, wherein at least the graded index lens and the light path deflection section are installed on the slider.

2. The optical head of claim 1, the graded index lens comprises a first index graded lens having a first refractive index profile and a second index graded lens having a second refractive index profile.

3. The optical head of claim 1, the light path deflection section is a prism.

4. The optical head of claim 1, an optical path length between the other end surface from which the incident light is transmitted and the position where the light spot is formed satisfies following conditional equation:
0.5×d×n<s<n×(b+n×(b²+f²)^{1/2})
where d: diameter of the graded index lens;
s: an optical path length between the other end surface from which the incident light is transmitted and the position where the light spot is formed;
b: length of the slider in a direction in which the graded index lens and the light deflection section are aligned;
n: refractive index of a medium in the optical path between the other end surface from which the incident light is transmitted and the position where the light spot is formed;
f: the maximum permissible height in the direction in which the slider floats from the position where the light spot is formed to the position where the light from the graded index lens provided on the slider is output.

5. The optical head of claim 1, wherein the diameter of the linear optical guide and the diameter of the graded index lens are substantially same.

6. The optical head of claim 1, further comprising a bench to fix the index grade lens.

7. The optical head of claim 6, the bench and the light path deflection section are integrally formed.

8. The optical head of claim 1, the light radiated from the linear optical guide does not pass through an air layer until the light forms the light spot at the position.

9. The optical head of claim 1, wherein the slider is provided with an optical waveguide that includes a light incident surface where the light spot is formed and the optical waveguide guides the light spot incident on the light incident surface and radiates the light spot to the recording medium.

10. The optical head of claim 9, further comprising a plasmon probe for generating near field light provided at a position where the light is transmitted from the optical waveguide or near the position.

11. The optical head of claim 1, further comprising a plasmon probe for generating near field light at a position where the light is transmitted from the optical waveguide or near the position.
the position where the light spot is formed is a surface of the slider facing the recording medium.

12. The optical head of claim 11, further comprising a plasmon probe for generating near field light provided at a position where the light spot is formed and transmitted or provided near the position.

13. The optical head of claim 1, further comprising magnetic recording element.

14. An optical recording apparatus comprising:
a recording medium;
the optical head of claim 1; and
a control section to control the recording medium and the optical head.
